(19) United States
(12) Patent Application Publication
(10) Pub. No.: US 2014/0058848 A1
(43) Pub. Date: Feb. 27, 2014

(54) COOPETITIVE AD AUCTION SYSTEM AND METHOD

(71) Applicants: Kamal Jian, Bellevue, WA (US); Christopher A. Wilkens, Fremont, CA (US); Darrell Hoy, San Jose, CA (US)

(72) Inventors: Kamal Jian, Bellevue, WA (US); Christopher A. Wilkens, Fremont, CA (US); Darrell Hoy, San Jose, CA (US)

(73) Assignee: eBay Inc., San Jose, CA (US)

(21) Appl. No.: 13/931,679

(22) Filed: Jun. 28, 2013

Related U.S. Application Data
(60) Provisional application No. 61/691,780, filed on Aug. 21, 2012.

(51) Int. Cl. G06Q 30/02

(52) U.S. Cl. CPC G06Q 30/0275
USPC 705/14.71

(57) ABSTRACT

A single advertisement may provide benefits to multiple parties. The results discussed herein show that an ad auctioneer may improve both his own revenue and consumers' welfare by implementing an ad auction that allows cooperation among advertisers in a single ad while maintaining competition between ads. This may be called a “coopetitive” ad auction. An auction system may be configured to implement a coopetitive approach in which bids express complex preferences over ads. In particular, multiple bidders may be allowed to value a single ad, and a single bidder may be allowed to value multiple ads. Accordingly, an advertiser can derive value from clicks on multiple ads.

### RELATED APPLICATIONS

This application claims the priority benefit of U.S. Provisional Patent Application No. 61/691,780, filed Aug. 21, 2012, which is incorporated herein by reference in its entirety.

### TECHNICAL FIELD

The subject matter disclosed herein generally relates to the processing of data. Specifically, the present disclosure addresses systems and methods to facilitate a coopetitive ad auction.

### BACKGROUND

A product may be manufactured by a manufacturer and available for purchase from a seller. For example, the product may take the form of a good (e.g., a physical object), a service (e.g., performed by a service provider), information (e.g., digital media), a license (e.g., authorization to access something), or any suitable combination thereof. An item may be a specimen (e.g., an individual instance) of the product, and multiple items may constitute multiple specimens of the product. Accordingly, a seller of a product may seek to merchandise one or more items as specimens of the product.

In merchandising an item, the seller may use a network-based system to present the item to a user of the network-based system (e.g., a potential buyer of the item). Examples of network-based systems include commerce systems (e.g., shopping websites), publication systems (e.g., classified advertisement websites), listing systems (e.g., auction websites), and transaction systems (e.g., payment websites). The item may be presented within a document (e.g., a webpage) that describes the item or product. In shopping for an item, one or more users may search the network-based system (e.g., by submitting queries) for such documents or similar information regarding details of the item or product.

Advertisements for items may be displayed to users of a search engine, and locations (e.g., placements) for such advertisements within a web page (e.g., within a graphical layout of the webpage) may be sold to advertisers (e.g., via auction, or other price setting algorithm). For example, auctions of advertising space or advertising time on a web page may enable an advertiser to bid on a top slot within a list of ad slots. Supposing the advertiser's bid is the highest bid received, the web page may show the advertiser's ad in that top slot. If a user (e.g., a viewer) of the web page clicks on that ad in the top slot, the advertiser may pay the bid price for that user's click.

### BRIEF DESCRIPTION OF THE DRAWINGS

Some embodiments are illustrated by way of example and not limitation in the figures of the accompanying drawings.

FIG. 1 is a screen capture illustrating advertisements being displayed on a web page of search results returned by a search engine, according to some example embodiments.

FIG. 2 is a network diagram illustrating a network environment suitable for a coopetitive auction, according to some example embodiments.

FIG. 3 is a block diagram illustrating components of an ad auction machine, according to some example embodiments.

FIGS. 4 and 5 are flowcharts illustrating operations of the ad auction machine in performing a method of implementing a coopetitive ad auction, according to some example embodiments.

FIG. 6 is a block diagram illustrating components of a machine, according to some example embodiments, able to read instructions from a machine-readable medium and perform any one or more of the methodologies discussed herein.

### DETAILED DESCRIPTION

Example methods and systems are directed to auctions, such as auctions of advertisements (e.g., auctions of advertising space, time, or both) and, in particular example embodiments, coopetitive ad auctions. Ad auctions (e.g., search ad auctions) are discussed herein has illustrative examples of auctions that may implement any one or more of the methods and systems discussed herein. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A single advertisement may provide benefits to multiple parties. For example, an ad for a Samsung laptop computer may benefit Microsoft, who sells the operating system for the laptop computer. This phenomenon may be studied with respect to auctions of search ads (e.g., auctions of advertisements shown to users of the search engine or “search advertising auctions”), and standard solutions may perform poorly. Such standard solutions include ignorance of mutual benefit and a benefit-aware Vickery-Clarke-Groves mechanism. In contrast, an appropriate first-price auction may exhibit nice equilibria in a single-slot ad auction. Such equilibria that satisfy a natural cooperative envy-freeness condition may select the welfare-maximizing ad and satisfy an intuitive lower-bound on revenue.

There may be several beneficiaries from the advertising of items and their subsequent sale. Imagine as an example that TigerDirect is selling a computer at a selling platform (e.g., eBay or Google). Suppose the computer is manufactured by Samsung, contains the latest Intel chip (e.g., processor), and has installed the Microsoft Office product and the Microsoft Windows operating system (OS). Imagine that the selling platform is configured to facilitate an advertisement auction in which the top listing on a web page is the one in which the selling platform makes the most money, the next highest listing on the web page is the one in which the selling platform makes the next highest amount of money, and so on. This type of auction might only take into account the additional profit which TigerDirect would make by selling this computer. Thus, only TigerDirect would be offering a bid to the selling platform. However, other stakeholders (e.g., Samsung, Intel, and Microsoft) in selling this computer may stand to profit if the computer is sold. According to example embodiments of the systems and methods discussed herein, the stakeholders may be provided with one or more direct ways in which to participate in the sale of the computer. An auction protocol is discussed herein, along with a mathematical analysis regarding the dynamics of how the bidding works in this auction protocol.

In 1991, Intel launched its “Intel Inside” advertising campaign and forever changed the way people buy computers. Previously, buyers only considered hardware insofar as it affected the software that would run on their new machine. The “Intel Inside” campaign aimed to change that behavior. Intel coordinated with PC vendors to advertise not only the processor's capabilities, but the Intel brand as well. Twenty years later, the “Intel Inside” mark has become one of the most recognized in the tech industry. Their signature five-note chime is known worldwide. Thus, today's buyers also think about the brand of processor inside their computer.

The benefit obtained from the “Intel Inside” campaign is an example of a general phenomenon. Intel has a vested interest in the sale of computers containing its products and, at least in an amortized sense, derives a specific benefit from every sale. Accordingly, a single advertisement may benefit many different companies. Companies may recognize this benefit and team up with partners in so-called cooperative advertising agreements (e.g., similar to the “Intel Inside” campaign). In 2000, an estimated $15 billion was spent on cooperative advertising in the United States alone. This phenomenon is also recognized in the operations research and marketing fields where it has been modeled using a variety of Stackelberg and dynamic games. In practical and theoretical realms, the question may be posed: how can companies who sell advertising space exploit the broad benefit of a single ad? This particular question is discussed herein in the context of online ad auctions. However, the methods and systems discussed herein may also be applied outside this context.

The results discussed herein indicate that an ad auctioneer (e.g., a facilitator or administrator of ad auctions) may improve both his own revenue and consumers' welfare by implementing an ad auction that allows cooperation among advertisers in a single ad on maintaining competition between ads. This may be termed a “coopetitive” ad auction. Coopetition may be used as a business term describing an environment where the same parties are simultaneously cooperating in some areas while competing in others. Also, as discussed below, external cooperative advertising contracts and the Vickery-Clarke-Groves (VCG) mechanism may perform poorly in a coopetitive ad auction (e.g., in comparison to a first-price auction).

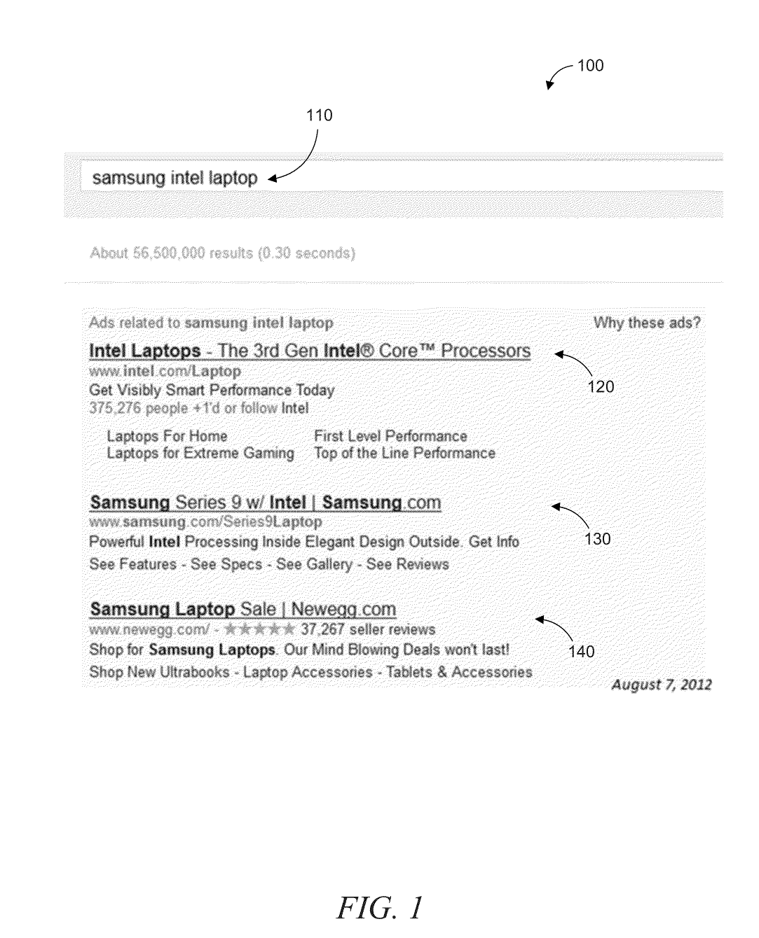

FIG. 1 is a screen capture illustrating ads (e.g., search ads) displayed on a web page 100 of search results returned by a search engine, according to some example embodiments. FIG. 1 shows a real query 110 in which a search engine's ad auction produces an outcome that fails to provide coopetitive benefits. In contrast and as discussed below, equilibria of a first-price auction which satisfy a cooperative envy-freeness condition may have a natural performance guarantee similar to that of a second-price auction.

As shown in FIG. 1, a search engine's web page 100 of search results for the query 110 for “samsung intel laptop” illustrates what may happen when the mutual benefits of an ad are ignored. A top-slotted ad 120 for “Intel Laptops” is competing against an ad 130 that appears below it for “Samsung Series 9 w/ Intel.” In reality, Intel would benefit if a user clicks on the Samsung ad 130 (and possibly even a Newegg ad 140 below both), and thus Intel should be unwilling to pay the premium costs of winning the top ad slot for the “Intel Laptops” ad 120.

Hence, web page advertisements may directly or indirectly benefit multiple parties (e.g., mutually and cooperatively). For example, an iPhone ad benefits cell phone providers; a Samsung ad for a Windows laptop benefits Microsoft; and an ad for the Boston Red Sox benefits a bar across the street from Fenway Park. Moreover, these secondary benefits may be significant. For example, when Best Buy sells a Samsung laptop running Windows, Microsoft may generate more money than either Best Buy or Samsung from the laptop's sale. As a result, companies may have stronger incentives to share advertising costs, particularly when competing against a more integrated adversary, such as when Microsoft and Samsung compete together against Apple.

One technique for pooling advertising dollars is an ad-hoc system of external contracts (e.g., external cooperative advertising contracts). In such external contracts, one company agrees to pay a portion of another's advertising costs when its own branding is included in the ads. In the Intel example, Intel agrees to pay a percentage of the advertising costs when Samsung or Dell include the “Intel Inside” branding in their ad.

In the research community, cooperative advertising may be studied in marketing and operations research. The setting may be modeled as a Stackelberg game in which an upstream manufacturer makes an offer to downstream manufacturers or retailers, sometimes incorporating dynamic components. In some example embodiments, the upstream manufacturer is not the first mover (e.g., in proposing an external contract), and the external contracts may be based on alternative bargaining solutions.

Search advertising may be sold through a pay-per-click (PPC, also called “price-per-click”) ad auction. In certain example embodiments, each bidder comes to the auction with its own ad and places a bid in terms of its willingness to pay for each click. The ad auctioneer may subsequently assign ads to ad slots on the web page. Thus, bidders may compete for slots. In some example embodiments, the ad auctioneer might only charge a bidder when the bidder's ad is selected (e.g., clicked).

In some example embodiments of a PPC ad auction, the only way for advertisers to share costs is through external contracts. Unfortunately, this approach may create undesirable results in an auction format. For example, an advertiser (e.g., a manufacturer) may compete with itself. As depicted in FIG. 1, the search engine query 110 for “samsung intel laptop” may return a web page (e.g., web page 100 of search results) in which the ad 120 from Intel is shown above the Samsung ad 130 that explicitly advertises Intel-based laptops. In general, Intel should be happy if the buyer visits Samsung's web site with an intent to buy an Intel-based laptop. Thus, even if Intel would prefer that the user click on its own ad 120 instead of Samsung's ad 130, Intel should be unhappy paying a premium cost to beat Samsung in the ad auction for the top slot on the web page (e.g., web page 100).

Another downside to external cooperative advertising agreements is that downstream producers may face a moral hazard. In some situations, the downstream producer may be incentivized to overspend on advertising and, thus, waste the upstream manufacturer's money. In the worst case scenario, the upstream manufacturer refuses to participate and cooperation collapses entirely. Examples of both phenomena are provided below.

The example methods and systems described herein (e.g., in the context of theories of mechanism design) implement another approach in which bids express complex preferences over ads. In particular, such example methods and systems allow multiple bidders to value a single ad and may allow a single bidder to value multiple ads. Performance of such example methods and systems may depend on the mechanism (e.g., auction algorithm) implemented. For example, a Vickery-Clarke-Groves (VCG) auction may generate little or no revenue. The implicit cooperation among advertisers, which may be desired, may mimic the kind of strategic collusion that reduces revenue in VCG mechanisms.

In contrast to external contracts and VCG mechanisms, first-price auctions which consider bidders' complex preferences may generally have nice equilibria in single slot settings. In the discussion below, the intuition of a second-price auction is generalized to give a lower-bound on the revenue that the auctioneer should expect. Also, the discussion below shows that equilibria (e.g., all equilibria) satisfying a natural cooperative envy-freeness condition will maximize welfare while satisfying this revenue lower-bound. It will be further shown that the cooperatively envy-free (CEF) equilibria dominate VCG auctions in terms of revenue. Each individual bidder pays more in the first-price auction than in the VCG mechanism.

Moreover, the below discussion shows how such cooperative envy-free equilibria can be found. The envy-freeness constraints define a polytope of which the equilibria form the Pareto frontier, and the below discussion introduces a family of convex programs for computing equilibria. Furthermore, the egalitarian equilibrium is specifically identified, and an efficient algorithm for computing it is provided herein.

According to various example embodiments, first-price auctions may be preferable to VCG and generalized second-price (GSP) auctions. For example, first-price auctions tend to be more transparent. Since prices precisely correspond to bids, bidders do not face uncertainty in their payments, and there is no opportunity for the auctioneer to manipulate the auction, particularly by learning in a repeated setting.

The systems and methods discussed herein may be applied to auctions with externalities. Whereas simple auction models may assume players (e.g., bidders) are indifferent to the bundle received by another player (e.g., a bidder), in reality there may be externalities. For example, players may care about the bundles received by other agents (e.g., bidders). Incorporation of externalities (e.g., accounting for one or more externalities) may produce an auction mechanism in which bidders can express a different value for every possible outcome. The methods and systems discussed herein might not always have nice interpretations in terms of externalities. However, like mechanisms that account for externalities, such methods and systems might not be easily expressed in a standard bidding language and, in extreme situations, may degenerate into a mechanism which involves bidders expressing a value for every possible outcome.

A coopetitive advertising model may be or include a generalized form of a PPC advertising auction. As in a PPC auction, the auctioneer in a coopetitive ad auction chooses which of m competing ads to show in s slots. Each advertiser derives a value of v from a click on one of its ads and has a utility that is quasi-linear in money, e.g., u(p)=v−p when the advertiser gets a click and pays p. The likelihood that a user clicks on ad j in slot k, called the click-through-rate (CTR), is given by c_{j,k}. Hence, the expected utility of a bidder whose ad is shown in slot with CTR c is E[uᵢ(pᵢ)]=c(v−p). The discussion herein focuses on a special case with only one slot (s=1) where CTRs are independent of the ad. In this case, the CTR can be taken to be 1 without loss of generality, so CTRs may be disregarded for the purposes of the discussion herein.

A new feature of the coopetitive model is that an advertiser can derive value from clicks on multiple ads. In general, the advertiser i's value for a click v_{i,j} depends on the particular ad j. However, for the sake of clarity, a simpler model is presently discussed.

An advertisement j∈{1, . . . , m} is defined by a publicly-known set of advertisers Sⱼ⊂[n] who all derive value from a click on the advertisement j. Advertiser i derives the same value vᵢ from a click on any ad j where i∈Sⱼ (and advertiser does not benefit if i∉Sⱼ). Let T denote the ad set of bidders in the ad with the maximum total value such that T=argmax_{S}_{ⱼ}Σ_{i∈}_{S}_{ⱼ}vᵢ (in case of a tie, T denotes the particular winning ad chosen by the auction). The results discussed herein are generalized to the more complicated v_{i,j} setting by considering equilibria where a bidder bids for the same surplus v_{i,j}−b_{i,j} in each ad.

In the discussion below, shorthand may be used for certain examples. This notation is itself best described by an example:

### {(A²,B¹,C³), (A²,B¹), (C³)}.

This example denotes an auction with three advertisers A, B, and C whose values are 2, 1, and 3 respectively. Everyone derives value when the first ad (A²;B¹;C³) is shown; only advertisers A and B benefit from the second ad; and only advertiser C benefits from the third.

External contracts provide a way in which advertisers may cooperate. Each ad may be “owned” (e.g., purchased or won) by a single bidder, and any party wishing to increase the bid on an ad may negotiate an external contract with the ad's owner.

This may be modeled as a standard VCG PPC ad auction in which advertiser i can commit to pay an αᵢ fraction of the cost each time one of its ads is clicked, up to a maximum βᵢ. This payment goes directly to the owner o(j) of the clicked ad j. Thus, the utility of advertiser i would be

uᵢ=vᵢ−min(αᵢpₒ₍ᵢ₎,βᵢ), while the utility of the ads owner o(j) would be uₒ₍ⱼ₎=vₒ₍ⱼ₎−pₒ₍ⱼ₎+min(αᵢpₒ₍ⱼ₎,βᵢ).

In the setting discussed herein, with a single slot, a VCG mechanism chooses the ad j that maximizes Σ_{i∈S}_{ⱼ}vᵢ and charges the bidder i the minimum value he needed to have to secure the winning ad. Bidders submit their true values vᵢ, because VCG auctions are incentive compatible.

In a first-price auction, however, each advertiser submits a bid bᵢ. The auctioneer displays the ad j that maximizes Σ_{i∈S}_{ⱼ}bᵢ, and the auctioneer charges each bidder in the winning ad pᵢ=bᵢ when the ad is clicked.

Many standard mechanisms may behave poorly with respect to advertisers coopetitive valuations. For example, FIG. 1 shows how one ad auction system caused Intel to compete against itself.

A few pitfalls specifically arise with the use of external contracts. First, if an external contract is made with insufficient granularity, an advertiser might easily compete with itself:

### Example 1

Consider the following two single-slot ad auctions:

### {(S³,M¹⁰), (D²,M¹⁰), (A¹¹)} and {(S³,M¹⁰), (D²,M¹⁰)}.

In the first ad auction, M will happily contribute advertising funds to help beat A; however, in the second auction M wins regardless. The only effect of M's dollars in the second auction is to fund a useless bidding war between the SM and DM ads.

In reality, the granularity of cooperative advertising contracts may be somewhat limited, so this may be a legitimate concern in spite of the fact that it is clearly not an equilibrium for M to offer a cooperative advertising contract in the second auction.

Additionally, the advertiser receiving the external contract may face a moral hazard; he may be incentivized to overspend the money of his advertising partner. In equilibrium, a potential result is that cooperation collapses:

### Example 2

Consider the following three ads with four interested parties:

### {(S³,M¹⁰), (D²,M¹⁰), (A¹¹)}

Suppose there are three ad slots with CTRs of 0.1, 0.08, and 0.05 respectively. If a bidder appears in multiple ads, their likelihood of a click is the sum of the likelihoods for those ads.

In the external contracts model described above, M will not offer a cooperative advertising contract in equilibrium. As a result, not only will revenue be hurt, but the auction will be inefficient, because the (A¹¹) ad wins the auction.

In contrast to an external contract, a VCG auction mechanism charges a player based on the externality the player imposes on other users (e.g., the welfare that others lose because of the player's presence). A potential downside of the VCG mechanism may be a failure to generate any revenue. Collusion may have a negative effect on revenue in the VCG mechanism. While such collusion can be illegal in other settings, it may be desirable for advertisers to cooperate on ads that are of mutual benefit in coopetitive ad auctions.

For example, two players can make their payments zero by simultaneously claiming sufficiently large values for the winning outcome o. If the players' bids are sufficiently large that o is still the welfare-maximizing outcome, even if one of the pair were removed, the externality that each player imposes is zero, and no player pays anything. This may happen in coopetitive ad auctions. For example:

### Example 3

In the following single slot ad auction {(A¹,B¹,C¹,D¹), (E³)}, the VCG mechanism shows the first ad in the slot, but nobody pays anything.

In this case, the ABCD ad remains the best ad, even if a single bidder is removed. As a result, no players pay. Such a scenario may occur when many players value the winning ad. For example, such a case can occur naturally if a single ad is valued by many small bidders.

The weak revenue of the VCG mechanism may not be limited to extremes like the above example. In general, payments may be lower than an auctioneer might hope. For example:

### Example 4

In the following single slot ad auction, {(A²,B²), (E³)}, the VCG mechanism shows the first ad in the slot, and players A and B each pay 1.

Intuition may suggest that the auctioneer should hope to make A and B pay a total of 3, since that is the total bid required to beat E. However, the total VCG payment for the first ad is only 2. In contrast, a coopetitive first-price auction would indeed generate a revenue of 3, as discussed below.

It may be useful to consider the behavior (e.g., equilibria) of first-price auctions in a coopetitive ad auction. Coopetitive ad auctions may differ from non-coopetitive ad auctions in that advertisers involved in the same ad are expected to cooperate on that ad, but remain competitors across other ads. For example, two sponsors (e.g., members) of a losing ad may jointly raise their bids so as to make their joint ad win.

Accordingly, the discussion presently focuses on first-price auction equilibria that are CEF. By this, it is meant that no cooperating advertisers in a losing ad can jointly raise their bids to beat out the presently winning ad. If a losing ad shares bidders with the winning ad, then it is only the advertisers not participating in either ad which affect this condition.

Definition 1: The bids (bᵢ)i∈T for the winning ad T are CEF if and only if for all alternate ads Sⱼ,

$${\sum }_{i ∈ T \backslash {S}_{j}}^{ } {b}_{i} \geq {\sum }_{i ∈ {S}_{j} \backslash T}^{ } {v}_{i} \qquad ( 1 )$$

Furthermore, the agents bidding may be individually rational (IR), such that for each advertiser i, 0≦bᵢ≦vᵢ.

Combining IR and CEF yields efficiency. If the bids of agents in T\Sⱼ are at least the values of agents in Sⱼ\T, then so too are the values of the agents in T\Sⱼ.

Lemma 4.1: If the bids (bᵢ)i∈T or the winning ad T are IR and CEF, then T is the efficient winning ad.

These CEF and IR conditions form a polytope of possible payments associated with the correct winning ad. Not all of these are equilibria; those that are not equilibria will instead form the lower frontier of the polytope. On this frontier, there can still be many possible equilibria. Consider the following ad auction: {A¹⁰⁰,B¹⁰⁰), (C⁹⁹)}. Every set of bids b_{A}=x, b_{B}=99−x for 0≦x≦99 constitutes an equilibrium.

Now, consider the equilibrium conditions. By CEF, no losing advertisers will be able to raise their bids and affect the outcome. Hence, it is sufficient to worry only about the winning bidders lowering their bids.

Lemma 4.2: The IR, CEF bids (bᵢ) form an equilibrium for the winning ad T if and only if for each bidder k, bₖ=0 or there exists an ad Sⱼ [symbol] k such that

$${\sum }_{i ∈ T}^{ } {b}_{i} = {\sum }_{i ∈ {S}_{j}}^{ } {b}_{i} \qquad ( 2 )$$

Proof First, consider the “if” direction. Assume such an Sⱼ exists for every k. If k were to lower his bid, Sj would win, and k would no longer be in the winning set.

Consider the other direction. Assume a set of equilibrium bids are CEF and IR. For every winning advertiser k, they must not be able to lower their bids and still win. Otherwise, the winning advertiser k would lower his bid, and there will be no equilibrium. Thus, for any k such that bₖ>0, there is such a set Sⱼ.

Next, consider the revenue behavior of equilibrium points in the polytope. First, it is noted that the revenue is not the same for all equilibrium points. This is not simply a matter of dividing up a fixed payment. As an example, consider the following setting with three ads and five interested parties: {(A¹,B¹,C¹), (A¹,D¹), (B¹,E¹)}. The first ad should win, but what should the payments be?

The CEF and IR conditions result in the following polytope: b_{A}+b_{C}≧1, b_{B}+b_{C}≧1, 0≦b_{A}, b_{B}, b_{C}≦1. The set of equilibrium points includes (1, 0, 1), (0, 1, 0) and every convex combination of the two. Thus, the revenue of the equilibrium points may range from 1 to 2.

How would other mechanisms fare? VCG would charge nothing, because no advertiser is integral to the ad being displayed. If A and B were to lie and say they are not affiliated with C or D, then any second-price or first-price mechanism would insist on a payment of 1 from the three of them. In this example, the revenues of the first price equilibria are lower bounded by VCG, and by simpler first-price and second-price auctions.

Lemma 4.3: For every point in the IR, CEF polytope, the bids of each advertiser are lower bounded by their VCG payments.
Proof: Consider advertiser i. Let T be the winning ad, and let Sⱼ be the winning ad without i. If Sⱼ=T, then i's VCG payment is 0, and hence it is sufficient to only worry about the case that Sⱼ≠T. By the CEF constraints,

bᵢ≧Σ_{k∈S}_{ⱼ}_{\T}vₖ−Σ_{k∈S}_{ⱼ}_{\T-{i}}bₖ≧Σ_{k∈S}_{ⱼ}_{\T}vₖ−Σ_{k∈S}_{ⱼ}_{\T-{i}}vₖ.

The latter quantity is exactly i's VCG payment, and hence every advertiser's bid is at least their VCG payment.

One possible way of dealing with these situations, after determining which ad is the winning ad, is for all members of the winning ad to pretend to be uninterested in the losing ads. At this point, the members of the winning ad negotiate among themselves on how to split up a payment of the maximum bid throughout all other ads. The revenue of every point in the polytope will be at least the revenue of this mechanism.

Lemma 4.4: The revenue of any equilibria in the IR, CEF polytope is at least the maximum total value of non-winning advertisers in a non-winning ad.

This lemma follows directly from the CEF conditions. Note that this is the same as the revenue that a second-price auction would get if it treated advertisements as single agents and removed any interests of winning advertisers in losing ads.

Thus, any first-price equilibria that satisfies CEF (e.g., no losing advertisers can collaborate to increase their bids and win) has good revenue that beats both the VCG approach and an analogue to a second-price auction.

An egalitarian solution is presently considered. As discussed above, there are many ways the winners can split up payments while still satisfying the aforementioned equilibria and cooperative envy-freeness constraints. In a first-price auction, an exact split that bidders may be expected to reach may depend on preferences and bidding dynamics of the advertisers.

The present discussion considers one such split in particular: the egalitarian bargaining solution. In the egalitarian bargaining solution, the utility of the worst-off player is maximized, and on up the line. This can be defined as the equilibrium with the lexicographically maximum surplus (e.g., an equilibrium with and a lexicographically maximum surplus):

Definition 2: The egalitarian solution in the coopetitive first-price auction is an equilibrium that displays the highest surplus ad and charges advertisers so that the surplus vector is lexicographically maximal when bidders are ordered in terms of increasing surplus.

In many normal settings, this will result in all players sharing the generated surplus equally.

The egalitarian equilibrium may be algorithmically computed (e.g., by a machine, which may form all or part of a network-based system, such as a network-based commerce system or a network-based auction system) by repeatedly lowering bids uniformly. An example embodiment of such an algorithm is described in Algorithm 1.

Algorithm 1: An algorithm is presently described for computing the egalitarian equilibrium in a single-slot first-price auction.
Input: a coopetitive ad auction problem
Output: the egalitarian equilibrium bids bᵢ.
1. Set the bids of all advertisers to their values. Call T the winning ad.
2. Lower bids of advertisers in the winning ad T uniformly until some bidder i reaches bᵢ=0 or a constraint Σ_{i∈T}bᵢ≧Σ_{i∈S}_{ⱼ}bᵢ would be violated for some ad Sⱼ.
3. Fix the bids of advertisers in T\Sⱼ or fix the bid of i if bᵢ reached 0).
4. Repeat (2) and (3), lowering only unfixed bids until all bidders in T are fixed.
   Lemma 5.1: Algorithm 1 computes the egalitarian equilibrium point.
   Proof: First, it will be shown that the resulting point is efficient and cooperatively envy-free. Then, it will be shown that the resulting equilibrium is an egalitarian one.
   Begin with the following assertion:
   Assertion 1: The total bid for the winning ad T never drops below the bids of non-winning ads.
   At any point, the algorithm lowers only the bids of players in every ad tied for the highest value. As a result, every ad tied for the highest value is decreasing by the same amount. Thus, the winning ad at the beginning of the algorithm remains the winning ad at the end and hence the final winning ad is the ad with the most surplus.

At the end of the auction, as T remains the ad with the highest value and no non-winning advertisers see their surpluses decrease, the CEF constraints are satisfied for every alternate ad Sⱼ.

By Lemma 4.2, the point will be in equilibrium if and only if there is a set for every agent tied with the winning set that he is not in. The algorithm will stop when, for every bidder, there is such a set, or they are bidding zero. Hence, such an equilibrium may be reached.

Thus, the final point is an efficient, CEF point. The present discussion considers whether or not this final point is in fact the egalitarian solution. This may be proven with induction. Assume that the algorithm gives the egalitarian bargaining solution for the first i−1 lowest surplus advertisers. Next, consider the algorithm after those advertisers are fixed. In particular, the next time an advertiser has their bid fixed, with a surplus of z. At this point, there will be a set Sⱼ such that

$${\sum }_{i ∈ T \backslash {S}_{j}}^{ } max ( {v}_{i} - z , {b}_{i}^{′} ) = {\sum }_{i ∈ T \backslash {S}_{j}}^{ } {v}_{i} \qquad ( 3 )$$

First, note that the algorithm cannot reduce the bid of i further than the egalitarian solution. Otherwise, that would result in the egalitarian solution. Assume now that the algorithm results in a lower surplus for player i. Hence, i's bid is fixed before being lowered to his egalitarian surplus. According to the above mentioned assumptions,

Σ_{i∈T\S}_{ⱼ}max(vᵢ−z,b′ᵢ)>Σ_{i∈T\S}_{ⱼ}b′ᵢ≧Σ_{i∈t\S}_{ⱼ}bᵢ.

By the CEF constraints in the egalitarian solution,

Σ_{i∈T\S}_{ⱼ}bᵢ≧Σ_{i∈T\S}_{ⱼ}vᵢ.

Then, Σ_{i∈T\S}_{ⱼ}max(vᵢ−z,b′ᵢ)<Σ_{i∈T\S}_{ⱼ}bᵢ and hence Σ_{i∈T\S}_{ⱼ}b′ᵢ=Σ_{i∈T\S}_{ⱼ}bᵢ, since all advertisers with surplus less than z have the egalitarian surplus, and all advertisers with more surplus are in Sⱼ, b′ᵢ=bᵢ

As discussed above, a wide variety of ads provide value to more than one party, for example, ads for computers, cell phones, and even baseball teams, to name a few. As evidenced by the “samsung intel laptop” query 110 shown in FIG. 1, ad auctions without support for coopetitive ads discussed herein may completely fail to account for such shared benefits. While a search engine may enjoy a little extra revenue at Intel's expense in the interim, FIG. 1 does not represent a sustainable equilibrium. The theoretical results presented herein show that failure to account for the shared benefit of an advertisement can have a substantial negative effect on both welfare and revenue.

As a possible solution, it was shown above that a coopetitive first-price auction behaves well in equilibrium. In particular, all equilibria that satisfy cooperative envy-freeness may be efficient and may generate good revenue. Moreover, such equilibria may be efficiently computed. Finally, as noted above, these results may be generalized to a model where bidders have different values for different ads.

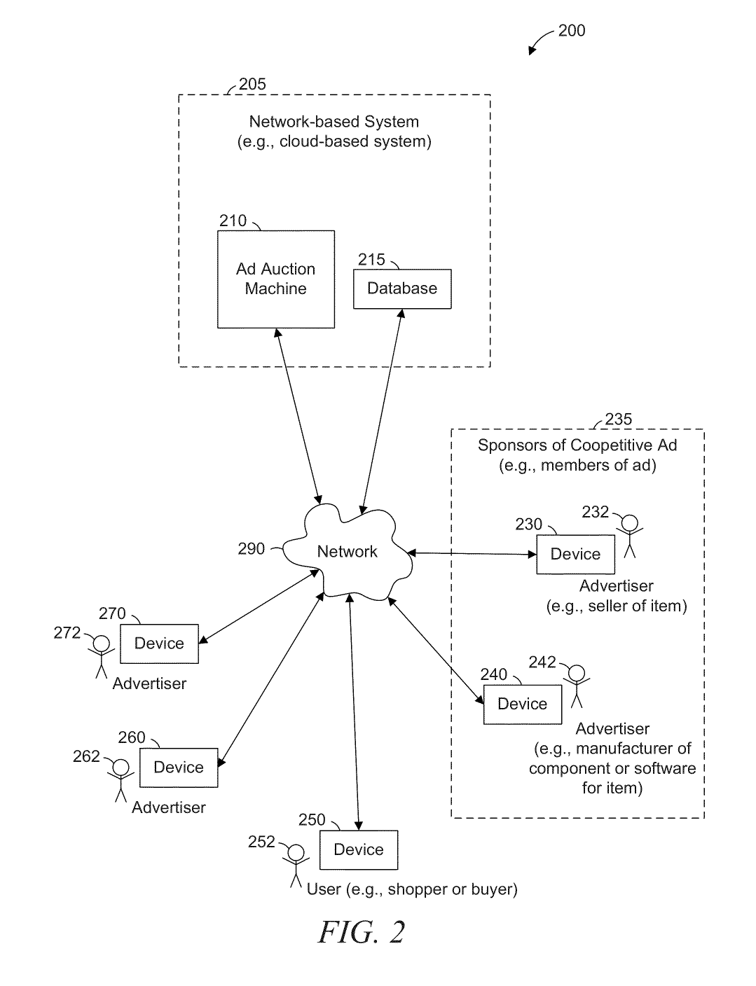

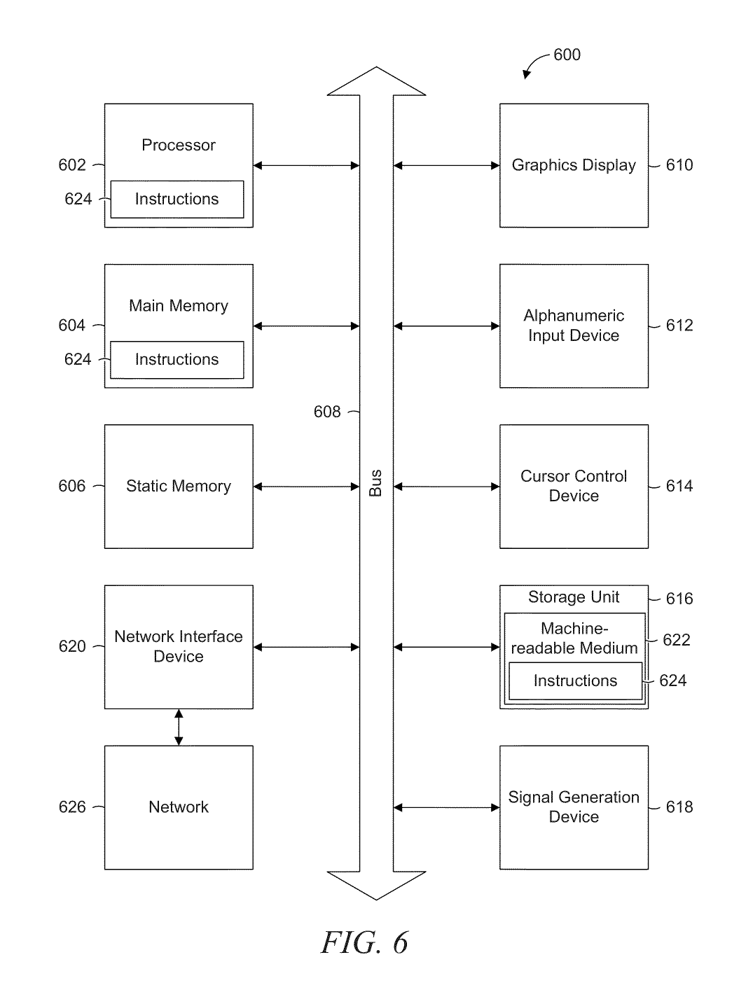

FIG. 2 is a network diagram illustrating a network environment 200 suitable for a coopetitive auction, according to some example embodiments. The network environment 200 includes an ad auction machine 210, a database 215, and devices 230, 240, 250, 260, and 270, all communicatively coupled to each other via a network 290. The ad auction machine 210, the database 215, and the devices 230, 240, 250, 260, and 270 may each be implemented in a computer system, in whole or in part, as described below with respect to FIG. 6.

The ad auction machine 210 may be configured (e.g., by software, such as software modules) to implement a coopetitive ad auction, in whole or in part. The database 215 may store ads, web pages, bids, payments, or any suitable combination thereof, in support of one or more operations performed by the ad auction machine 210. The ad auction machine 210, with or without the database 215, may form all or part of a network-based system 205 (e.g., a cloud-based server system) that provides one or more network-based auction services.

Also shown in FIG. 2 are users 232, 242, 252, 262, and 272. One or more of the users 232, 242, 252, 262, and 272 may be a human user (e.g., a human being), a machine user (e.g., a computer configured by a software program to interact with a device, such as the device 230), or any suitable combination thereof (e.g., a human assisted by a machine or a machine supervised by a human). As shown in FIG. 2, the user 232 may be an advertiser (e.g., a first advertiser, who may be a seller of an item available for sale). The user 242 may be an advertiser (e.g., a second advertiser, who may be a manufacturer of a component of the item available for sale, or a manufacturer of software installed in the item available for sale). The user 252 may be a viewer of a web page (e.g., a search results web page, such as web page 100) generated by the network-based system 205 (e.g., by the ad auction machine 210). For example, the user 252 may be an online shopper, a potential buyer of the item available for sale, or both. The user 262 may be an advertiser (e.g., a third advertiser, who may be a seller of a different item available for sale), and the user 272 may be an advertiser (e.g., fourth advertiser, who may be a manufacturer of a component of the different item, or a manufacturer of software installed in the different item). As shown in FIG. 2, the users 232 and 242 may constitute a group of sponsors 235 of a coopetitive ad for an item (e.g., an item whose sale benefits both the users 232 and 242). Likewise, the users 262 and 272 may form a similar group of advertisers or sponsors.

The user 232 is not part of the network environment 200, but is associated with the device 230 and may be a user of the device 230. For example, the device 230 may be a desktop computer, a vehicle computer, a tablet computer, a navigational device, a portable media device, or a smart phone belonging to the user 232. Likewise, the user 242 is not part of the network environment 200, but is associated with the device 240. As an example, the device 240 may be a desktop computer, a vehicle computer, a tablet computer, a navigational device, a portable media device, or a smart phone belonging to the user 242. Similar relationships may exist between the user 252 and the device 250, between the user 262 and the device 260, and the user 272 and the device 270.

Any of the machines, databases, or devices shown in FIG. 2 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 2 may be combined into a single machine, and the functions described herein for any single machine, database, or device may be subdivided among multiple machines, databases, or devices.

The network 290 may be any network that enables communication between or among machines, databases, and devices (e.g., the ad auction machine 210 and the device 230). Accordingly, the network 290 may be a wired network, a wireless network (e.g., a mobile or cellular network), or any suitable combination thereof. The network 290 may include one or more portions that constitute a private network, a public network (e.g., the Internet), or any suitable combination thereof.

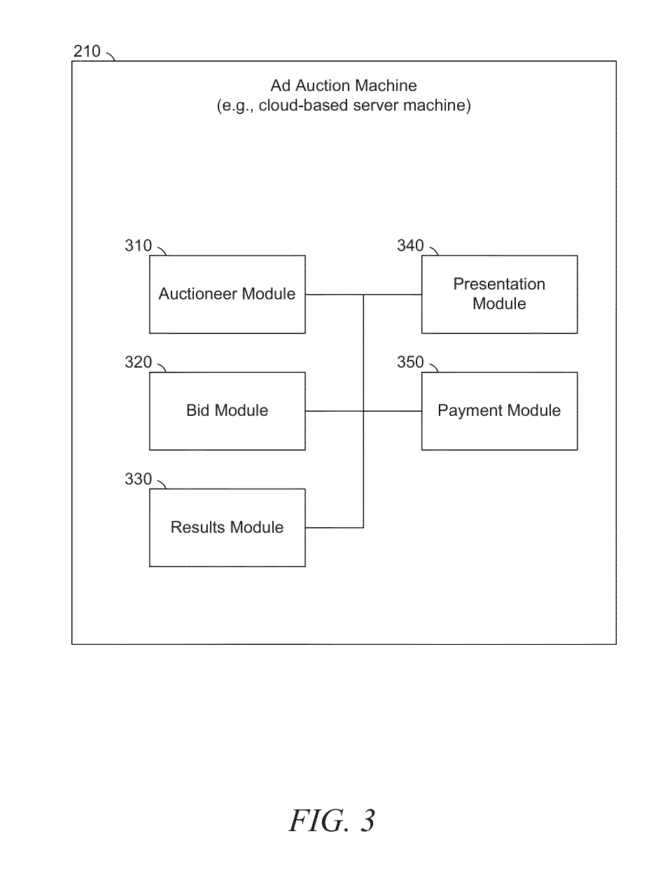

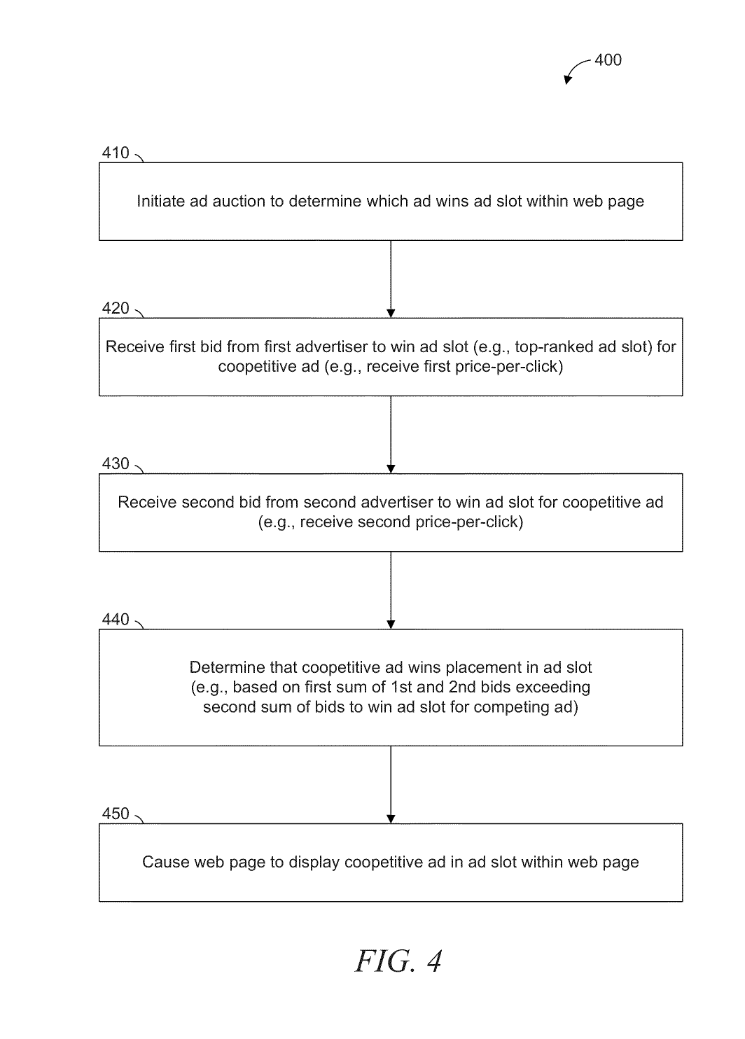

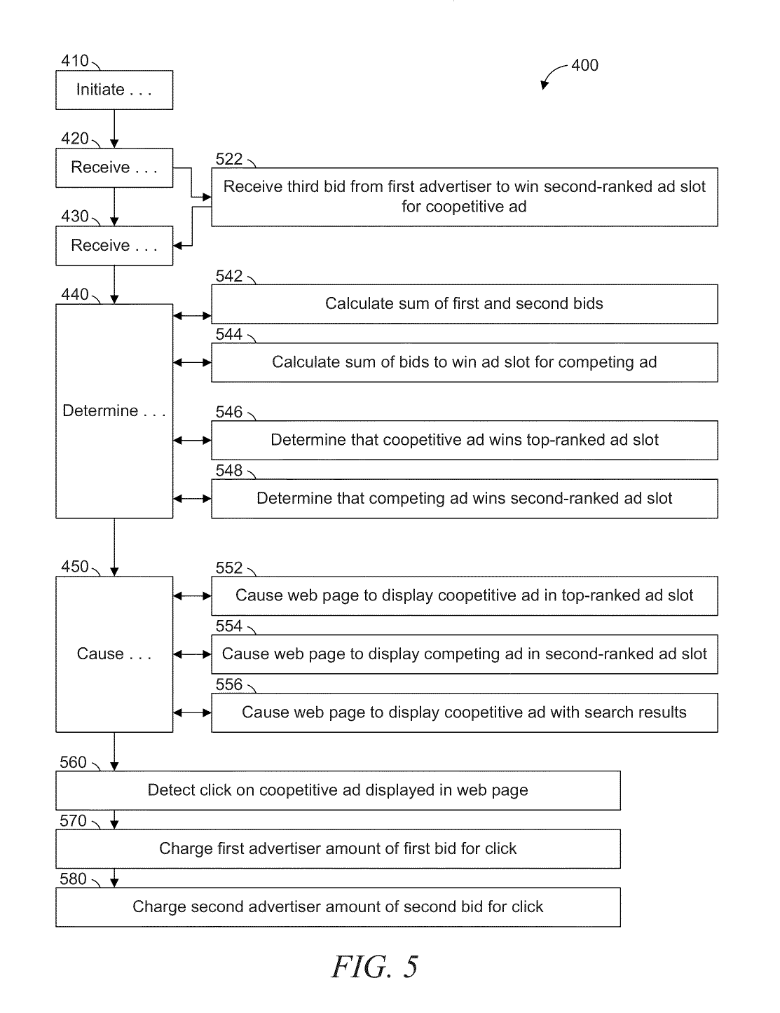

FIG. 3 is a block diagram illustrating components of the ad auction machine 210, according to some example embodiments. The ad auction machine 210 is shown as including an auctioneer module 310, a bid module 320, a results module 330, a presentation module 340, and a payment module 350, all configured to communicate with each other (e.g., via a bus, shared memory, or a switch). Functions of the various modules shown in FIG. 3 are discussed below with respect to FIGS. 4 and 5.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIGS. 4 and 5 are flowcharts illustrating operations of the ad auction machine 210 in performing a method 400 of implementing a coopetitive ad auction, according to some example embodiments. Operations in the method 400 may be performed by the ad auction machine 210, using modules described above with respect to FIG. 3. As shown in FIG. 4, the method 400 includes operations 410, 420, 430, and 440, and may include operation 450.

In operation 410, the auctioneer module 310 initiates an ad auction (e.g., a coopetitive auction of one or more search ad slots) to determine which of multiple ads (e.g., search ads) wins placement in an ad slot within a web page (e.g., web page 100 of search results). As discussed above, the multiple ads may include one or more coopetitive ads. In particular, a coopetitive ad among the multiple ads may advertise an item whose sale benefits multiple advertisers, such as a first advertiser (e.g., user 232) and a second advertiser (e.g., user 242). As an example, the item advertised by the coopetitive ad may be purchasable from the first advertiser and may include a component (e.g., a part) that is manufactured by the second advertiser. This situation is illustrated above with respect to a Samsung laptop with an Intel processor. As another example, the item advertised by the coopetitive ad may be purchasable from the first advertiser and includes software that is manufactured by the second advertiser. The situation is illustrated above with respect to a Samsung laptop having a Microsoft operating system. As described above, the first and second advertisers (e.g., users 232 and 242) may both be sponsors (e.g., co-sponsors or members) of the coopetitive ad and may both be bidders to place the coopetitive ad in the ad slot within the web page (e.g., web page 100 of search results).

In operation 420, the bid module 320 receives a first bid from the first advertiser (e.g., user 232). This first bid may be an auction bid to win the ad slot for the coopetitive ad. By this submission, the first advertiser may become a bidder on the ad slot, a sponsor (e.g., co-sponsor) of the coopetitive ad, or both. In some example embodiments, the first bid is treated as a first partial bid (e.g., first fractional bid) to be combined with other partial bids into an aggregate bid submitted by multiple co-sponsors of the coopetitive ad. In some example embodiments, the first bid represents a first price-per-click that the first advertiser is willing to pay (e.g., in cooperation with the second advertiser) for placement of the coopetitive ad into the ad slot within the web page (e.g., web page 100 of search results).

In operation 430, the bid module 320 receives a second bid from the second advertiser (e.g., user 242), and the second bid may be an auction bid to win the ad slot for the coopetitive ad. By this submission, the second advertiser may also become a bidder on the ad slot, a sponsor (e.g., co-sponsor) of the coopetitive ad, or both. In some example embodiments, the second bid is treated as a second partial bid (e.g., second fractional bid) to be combined with other partial bids into an aggregate bid submitted by multiple co-sponsors of the coopetitive ad. In some example embodiments, the second bid represents a second price-per-click that the second advertiser is willing to pay (e.g., in cooperation with the first advertiser) for placement of the coopetitive ad into the ad slot within the web page (e.g., web page 100).

In operation 440, the results module 330 determines the winning ad based on bids received by the bid module 320 (e.g., in operations 420 and 430). For example, the results module 330 may determine that the coopetitive ad (e.g., co-sponsored by the first and second advertisers) wins placement in the ad slot within the web page. This determination may be made based on a sum of the first and second bids to win the ad slot for the coopetitive ad. As an example, the sum of the first and second bids may exceed (e.g., be larger than) a sum of bids to win the ad slot for a competing ad (e.g., a different coopetitive ad co-sponsored by the users 262 and 272) among the multiple ads. For example, supposing that the ad auction is a first-price auction, each advertiser may submit a bid bᵢ. The results module 330 may determine the winner of the ad auction to be the ad j that maximizes Σ_{i∈S}_{ⱼ}bᵢ.

In operation 450, the presentation module 340 causes the web page (e.g., web page 100 of search results) to display the coopetitive ad (e.g., as the winner of the ad slot in the ad auction) in the ad slot. According to certain example embodiments, the presentation module 340 may be or include a web server, a web page generator (e.g., static or dynamic), or any suitable combination thereof. Operation 450 may be performed in response to the determining (e.g., the determination) that the coopetitive ad wins the ad slot in operation 440.

As shown in FIG. 5, the method 400 may include one or more of operations 522, 542, 544, 546, 548, 552, 554, 556, 560, 570, and 580, according to various example embodiments. For example, operation 522 may be performed before operation 440 (e.g., between operations 420 and 430). In some example embodiments, the ad slot discussed above with respect to operation 420 is a top-ranked ad slot (e.g., a highest or most prominent ad location within the web page) among multiple ad slots that are available on the web page (e.g., web page 100). In such situations, the ad auction may determine which ads will appear in multiple ad slots, such as a second-ranked ad slot (e.g., a next highest or next most prominent application within the web page). In operation 522, the bid module 320 receives another bid (e.g., a third bid) from the first advertiser (e.g., user 232), and this bid may be an auction bid to win a second-ranked ad slot for the coopetitive ad. Moreover, this bid may be different from the first bid discussed above with respect to operation 420. That is, the first advertiser (e.g., user 232) may submit different bids (e.g., bid different prices-per-click) for placing the coopetitive ad in the top-ranked ad slot and for placing the coopetitive ad in the second-ranked ad slot.

One or more of operations 542, 544, 546, and 548 may be performed as part (e.g., a precursor task, a subroutine, or a portion) of operation 440, in which the results module 330 determines the winning ad (e.g., the coopetitive ad) for the ad slot. In operation 542, the results module 330 calculates the sum of the first bid and the second bid (e.g., the sum of the first and second bids, as received in operations 420 and 430). As noted below with respect to operation 546, operation 440 may be performed based on this calculated sum. For example, operation 440 may be performed based on this calculated sum being larger than a competing sum of bids to win the ad slot for a competing ad. That is, operation 440 may be performed based on this calculated sum maximizing Σ_{i∈S}_{ⱼ}bᵢ.

In operation 544, a similar calculation is performed for the competing sum of bids to win the ad slot for the competing ad. Specifically, the results module 330 calculates the sum of competing bids to win the same ad slot for the competing ad (e.g., a different coopetitive ad that advertises a further item whose sale benefits a third advertiser and a fourth advertiser, such as the users 262 and 272). For example, the competing ad may be sponsored (e.g., co-sponsored) by multiple advertisers (e.g., users 262 and 272) that each submitted a separate bid for placement of the competing ad into the ad slot. Such separate bids may be received during the ad auction by the bid module 320 prior to operation 440. These separate bids may be summed to calculate the result of operation 544. As noted below with respect to operation 546, operation 440 may be based on this calculated sum. For example, operation 440 may be performed based on this calculated sum being smaller than the sum calculated in operation 542.

In operation 546, the results module 330 determines that the coopetitive ad discussed above with respect to operation 440 wins the top-ranked ad slot within the web page (e.g., web page 100 of search results). As noted above, this determination may be based on the result of operation 542, the result of operation 544, or both.

In operation 548, a similar determination is made for a second-ranked ad slot within the web page (e.g., web page 100 of search results). For example, the results module 330 may determine that a competing ad (e.g., a different coopetitive ad co-sponsored by a third advertiser and a fourth advertiser, such as the users 262 and 272) wins the second-ranked ad slot. This determination may be based on calculated sums of bids for placing one or more ads into the second-ranked ad slot (e.g., a sum that includes the third bid discussed above with respect to operation 522).

One or more of operations 552, 554, and 556 may be performed as part (e.g., a precursor task, a subroutine, or a portion) of operation 450, in which the presentation module 340 causes the web page (e.g., web page 100) to display the winning ad (e.g., the coopetitive ad) in the ad slot within the web page. In operation 552, the presentation module 340 causes the web page to display the coopetitive ad discussed above with respect to operation 450 in the top-ranked ad slot within the web page.

In example embodiments that include operation 548, in which the results module 330 may determine that a competing ad wins the second-ranked ad slot, operation 554 may be performed as part of operation 450. In operation 554, the presentation module 340 causes the web page (e.g., web page 100) to display the competing ad in the second-ranked ad slot.

In example embodiments where the ad auction is a search ad auction, operation 556 may be performed as part of operation 450. In operation 556, the presentation module 340 causes the web page (e.g., web page 100) to display the coopetitive ad discussed above with respect to operation 450 with search results (e.g., returned by a search engine in response to a search query submitted by the user 252).

According to various example embodiments, the ad auction machine 210 may detect a click on the coopetitive ad displayed in the web page (e.g., web page 100) and respond by initiating or otherwise processing respective charges to the co-sponsors of the coopetitive ad (e.g., users 232 and 242). Hence, one or more of operations 560, 570, and 580 may be performed after operation 450, in which the presentation module 340 causes the web page to display the coopetitive ad in the ad slot.

In operation 560, the presentation module 340 detects a click (e.g., performed by the user 252 via the device 250) on the coopetitive ad displayed in the web page (e.g., web page 100). In some example embodiments, a mouse over event may be used in place of a click.

In operation 570, the payment module 350 charges the first advertiser (e.g., user 232) a first amount that is equal to the first bid (e.g., placed by the first advertiser in operation 420). According to some example embodiments, the payment module 350 initiates such a charge to the first advertiser or otherwise begins processing such a charge. Operation 570 may be performed in response to the click being detected in operation 560.

In operation 580, the payment module 350 charges the second advertiser (e.g., user 242) a second amount that is equal to the second bid (e.g., placed by the second advertiser in operation 430). According to certain example embodiments, the payment module 350 initiates this charge to the second advertiser or otherwise begins processing this charge. Operation 580 may be performed in response to the click being detected in operation 560.

According to various example embodiments, one or more of the methodologies described herein may facilitate implementation, execution, and administration of a coopetitive auction, such as a coopetitive ad auction. Moreover, one or more of the methodologies described herein may facilitate an auction in which bids express complex preferences of bidders. Hence, one or more the methodologies described herein may allow multiple bidders to value a single object being auctioned (e.g., placement of the search ad within an ad slot), and a single bidder may be allowed to value multiple objects being auctioned (e.g., multiple ad slots on a web page).

When these effects are considered in aggregate, one or more of the methodologies described herein may obviate a need for certain efforts or resources that otherwise would be involved in facilitating coopetitive auctions. Efforts expended by administrators and bidders (e.g., advertisers) in implementing cooperative bidding relationships may be reduced by one or more of the methodologies described herein. Computing resources used by one or more machines, databases, or devices (e.g., within the network environment 200) may similarly be reduced. Examples of such computing resources include processor cycles, network traffic, memory usage, data storage capacity, power consumption, and cooling capacity.

FIG. 6 is a block diagram illustrating components of a machine 600, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 6 shows a diagrammatic representation of the machine 600 in the example form of a computer system and within which instructions 624 (e.g., software, a program, an application, an applet, an app, or other executable code) for causing the machine 600 to perform any one or more of the methodologies discussed herein may be executed, in whole or in part. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a distributed (e.g., peer-to-peer) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform all or part of any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 (e.g., a tangible and non-transitory machine-readable storage medium) on which are stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media (e.g., tangible and non-transitory machine-readable media). The instructions 624 may be transmitted or received over a network 626 (e.g., network 290) via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
initiating an ad auction to determine which of multiple ads wins placement in an ad slot within a web page,
a coopetitive ad among the multiple ads advertising an item whose sale benefits a first advertiser and a second advertiser;
receiving a first bid from the first advertiser to win the ad slot for the coopetitive ad;
receiving a second bid from the second advertiser to win the ad slot for the coopetitive ad;
determining that the coopetitive ad wins placement in the ad slot within the web page based on a sum of the first and second bids being larger than a sum of bids to win the ad slot for a competing ad among the multiple ads,
the determining being performed by a processor of a machine; and
causing the web page to display the coopetitive ad in the ad slot in response to the determining that the coopetitive ad wins the ad slot.

2. The method of claim 1, wherein:
the ad slot is a top-ranked ad slot within the web page;
the ad auction further determines which of the multiple ads wins placement in a second-ranked ad slot within the web page; and the method further comprises:
determining that the competing ad wins placement in the second-ranked ad slot; and wherein
the causing of the web page to display the coopetitive ad in the top-ranked ad slot includes causing the web page to display the competing ad in the second-ranked ad slot within the web page.

3. The method of claim 1, wherein:
the ad auction is a first-price auction.

4. The method of claim 1, wherein:
the ad auction is a search ad auction; and
the causing of the web page to display the coopetitive ad in the ad slot includes causing the web page to display search results with the coopetitive ad.

5. The method of claim 1, wherein:
the first bid represents a first price-per-click that the first advertiser is willing to pay for placement of the coopetitive ad in the ad slot; and
the second bid represents a second price-per-click that the second advertiser is willing to pay for placement of the coopetitive ad in the ad slot.

6. The method of claim 1 further comprising:
charging the first advertiser a first amount equal to the first bid in response to a click being detected on the coopetitive ad displayed in the ad slot; and
charging the second advertiser a second amount equal to the second bid in response to the click being detected on the displayed coopetitive ad.

7. The method of claim 1, wherein:
the competing ad is sponsored by multiple advertisers that each submit a separate bid for the ad slot during the ad auction; and
the sum of bids to win the ad slot for the competing ad sums the separate bids submitted by the multiple advertisers.

8. The method of claim 1, wherein:
the item advertised by the coopetitive ad is purchasable from the first advertiser and includes a component manufactured by the second advertiser.

9. The method of claim 1, wherein:
the item advertised by the coopetitive ad is purchasable from the first advertiser and includes software manufactured by the second advertiser.

10. The method of claim 1, wherein:
the first and second advertisers are both sponsors of the ad and both bidders to place the coopetitive ad in the ad slot within the web page.

11. The method of claim 1, wherein:
the ad slot is a top-ranked ad slot within the web page;
the ad auction further determines which of the multiple ads wins placement in a second-ranked ad slot within the web page; and the method further comprises:
receiving a third bid from the first advertiser to the second-ranked ad slot for the coopetitive ad,
the third bid being different from the first bid to win the top-ranked ad slot for the coopetitive ad.

12. A non-transitory machine-readable storage medium comprising instructions that, when executed by one or more processors of a machine, cause the machine to perform operations comprising:
initiating an ad auction to determine which of multiple ads wins placement in an ad slot within a web page,
a coopetitive ad among the multiple ads advertising an item whose sale benefits a first advertiser and a second advertiser;
receiving a first bid from the first advertiser to win the ad slot for the coopetitive ad;
receiving a second bid from the second advertiser to win the ad slot for the coopetitive ad;
determining that the coopetitive ad wins placement in the ad slot within the web page based on a sum of the first and second bids being larger than a sum of bids to win the ad slot for a competing ad among the multiple ads; and
causing the web page to display the coopetitive ad in the ad slot in response to the determining that the coopetitive ad wins the ad slot.

13. The non-transitory machine-readable storage medium of claim 12, wherein:
the ad auction is a first-price auction.

14. The non-transitory machine-readable storage medium of claim 12, wherein:
the first bid represents a first price-per-click that the first advertiser is willing to pay for placement of the coopetitive ad in the ad slot; and
the second bid represents a second price-per-click that the second advertiser is willing to pay for placement of the coopetitive ad in the ad slot.

15. The non-transitory machine-readable storage medium of claim 12, wherein the operations further comprise:
charging the first advertiser a first amount equal to the first bid in response to a click being detected on the coopetitive ad displayed in the ad slot; and
charging the second advertiser a second amount equal to the second bid in response to the click being detected on the displayed coopetitive ad.

16. A system comprising:
an auctioneer module configured to initiate an ad auction to determine which of multiple ads wins placement in an ad slot within a web page,
a coopetitive ad among the multiple ads advertising an item whose sale benefits a first advertiser and a second advertiser;
a bid module configured to:
receive a first bid from the first advertiser to win the ad slot for the coopetitive ad; and
receive a second bid from the second advertiser to win the ad slot for the coopetitive ad;
a processor configured by a results module to determine that the coopetitive ad wins placement in the ad slot within the web page based on a sum of the first and second bids being larger than a sum of bids to win the ad slot for a competing ad among the multiple ads; and
a presentation module configured to cause the web page to display the coopetitive ad in the ad slot in response to the determining that the coopetitive ad wins the ad slot.

17. The system of claim 16, wherein:
the ad slot is a top-ranked ad slot within the web page;
the ad auction further determines which of the multiple ads wins placement in a second-ranked ad slot within the web page;
the results module further configures the processor to determine that the competing ad wins placement in the second-ranked ad slot; and
the presentation module is further configured to cause the web page to display the competing ad in the second-ranked ad slot within the web page.

18. The system of claim 16, wherein:
the ad auction is a first-price auction.

19. The system of claim 16, wherein:
the first bid represents a first price-per-click that the first advertiser is willing to pay for placement of the coopetitive ad in the ad slot; and
the second bid represents a second price-per-click that the second advertiser is willing to pay for placement of the coopetitive ad in the ad slot.

20. The system of claim 16 further comprising:
a payment module configured to:
charge the first advertiser a first amount equal to the first bid in response to a click being detected on the coopetitive ad displayed in the ad slot; and
charge the second advertiser a second amount equal to the second bid in response to the click being detected on the displayed coopetitive ad.
